(19) United States
(12) Patent Application Publication
(10) Pub. No.: US 2023/0304550 A1
(43) Pub. Date: Sep. 28, 2023

(54) ELECTROMECHANICAL VEHICLE BRAKE AND METHOD FOR DETERMINING THE POSITION OF AN ELECTROMECHANICAL VEHICLE BRAKE

(71) Applicant: ZF Active Safety GmbH, Koblenz (DE)

(72) Inventors: Fabian Querbach, Lonnig (DE); Andreas Marx, Hartenfels (DE); Roman Bechmann, Koblenz (DE)

(21) Appl. No.: 18/187,378

(22) Filed: Mar. 21, 2023

(30) Foreign Application Priority Data
Mar. 24, 2022 (DE) 102022106982.6

(51) Int. Cl. F16D 65/18

(52) U.S. Cl. CPC F16D 65/18; F16D 2121/24

(57) ABSTRACT

An electromechanical vehicle brake has an electric motor and an actuation piston, which acts on a braking assembly, as well as a ball screw drive. The ball screw drive comprises a spindle rotatable by the electric motor and a ball screw nut displaceable on the spindle. The ball screw nut is received in the actuation piston and cooperates with a stop on an inner axial end of the actuation piston to displace the actuation piston in an actuation direction. A spring element is arranged in the actuation piston between the stop and the ball screw nut. A travel sensor measures a linear displacement of the actuation piston. With the aid of the signal of the travel sensor, which indicates a displacement position of the actuation piston, a braking force currently applied by the actuation piston to the braking assembly is determined under consideration of the characteristic curve of the spring element.

### CROSS-REFERENCE TO RELATED APPLICATION

This application claims priority to German Priority Application No. 102022106982.6, filed Mar. 24, 2022, the disclosure of which is incorporated herein by reference in its entirety.

### TECHNICAL FIELD

The disclosure relates to an electromechanical vehicle brake and to a method for determining a position of an electromechanical vehicle brake.

### BACKGROUND

In contrast to conventional hydraulically actuated brakes, in an electromechanical brake an electromotively moved element, for example a ball screw drive, is provided, which acts on a movable component of the brake in order to actuate the brake. Electromechanical brakes are used both as parking brakes and as conventional wheel brakes. In the case of use in a wheel brake, the electric motor moves a brake lining against a brake disc and thus generates the necessary braking pressure to close the brake.

It is desirable, during the actuation of the brake, to know the braking pressure or the braking force generated by the electric motor. Since the necessary actuation travel of the brake changes over the course of time, amongst other things due to wear, and the braking force therefore is not discernible merely by detection of the motor movement, conventional force sensors are used. The use of these sensors, however, is complex and costly.

### SUMMARY

What is needed is to make it possible to determine an applied braking force in an electromechanical vehicle brake without the use of a dedicated force sensor.

An electromechanical vehicle brake comprising an electric motor and an actuation piston which acts on a braking assembly is disclosed. The vehicle brake comprises a ball screw drive which has a spindle rotatable by the electric motor as well as a ball screw nut displaceable on the spindle, wherein the ball screw nut is received in the actuation piston and cooperates with a stop on an inner axial end of the actuation piston in order to displace the actuation piston in an actuation direction. In addition, the vehicle brake has a spring element, which is arranged in the actuation piston between the stop and the ball screw nut, and a travel sensor, which measures a linear displacement of the actuation piston, as well as a control unit, which is designed to use a signal of the travel sensor under consideration of a characteristic curve of the spring element in order to determine a braking force applied to the braking assembly.

With this arrangement it is possible to dispense with a force sensor on the vehicle brake.

Certain parameters of the electric motor, for example the torque applied to the spindle, and the current required therefor, change according to the position of the ball screw nut during displacement of the actuation piston. The known characteristic curve of the sprig element helps here to detect the position of the actuation piston, from which the spring element is fully compressed, and the braking assembly is closed. From this point, the braking force transferred by a continued movement of the actuation piston is distance-dependent approximately linearly. Due to the knowledge of the position of the actuation piston detected via the travel sensor and also the relationships, determinable beforehand, between the movable components, an applied braking force can thus now be determined.

For example, an operating current of the electric motor can be measured, which represents a measure for the torque of the spindle and also for the force that the ball screw nut transfers to the actuation piston. A torque-force ratio between the torque of the spindle and the force transferred by the actuation piston can thus be determined easily beforehand. A position of the ball screw nut that is known via the number of revolutions of the spindle can be included in order to determine the braking force.

In order to be able to determine the movement of the actuation piston directly and contactlessly, a signal transmitter is arranged on the actuation piston and its movement is detected by the travel sensor.

For example, a Hall sensor or a capacitive sensor, that is to say a robust and economical sensor, can be used as travel sensor.

The travel sensor, which detects the movement of the signal transmitter, s received in a portion of a housing of the vehicle brake adjacent to the actuation piston, so that the travel sensor can be well protected in the vicinity of the actuation piston.

The travel sensor is, for example, electrically contactable via a printed circuit board, which can be simplified further still if the travel sensor is mounted on a separate printed circuit board which is connected to the printed circuit board via a plug and/or line connection.

It can be provided here that the printed circuit board controls the electric motor and/or is part of the control unit.

The braking assembly comprises, for example, the brake pads and brake disc of a conventional wheel brake. In one exemplary arrangement, the braking assembly is a floating calliper brake.

A method for determining a position of the electromechanical vehicle brake as described above is also disclosed, With the aid of the travel sensor, which indicates a displacement position of the actuation piston, a braking force currently applied by the actuation piston to the braking assembly is determined under consideration of the characteristic curve of the spring element.

For this purpose, a current actuation current of the electric motor and/or a current torque of the spindle can optionally be taken into consideration additionally.

### BRIEF DESCRIPTION OF DRAWINGS

The disclosure will be described hereinafter in greater detail on the basis of an exemplary arrangement with reference to the accompanying figures, hi the figures:

FIG. 1 shows a schematic sectional view of a vehicle brake according to the disclosure for carrying out a method according to the disclosure;

FIG. 2 shows a further schematic illustration of a vehicle brake according to the disclosure for carrying out a method according to the disclosure; and

FIG. 3 shows a schematic illustration of a force-travel characteristic curve of the vehicle brake of FIGS. 1 and 2.

### DETAILED DESCRIPTION

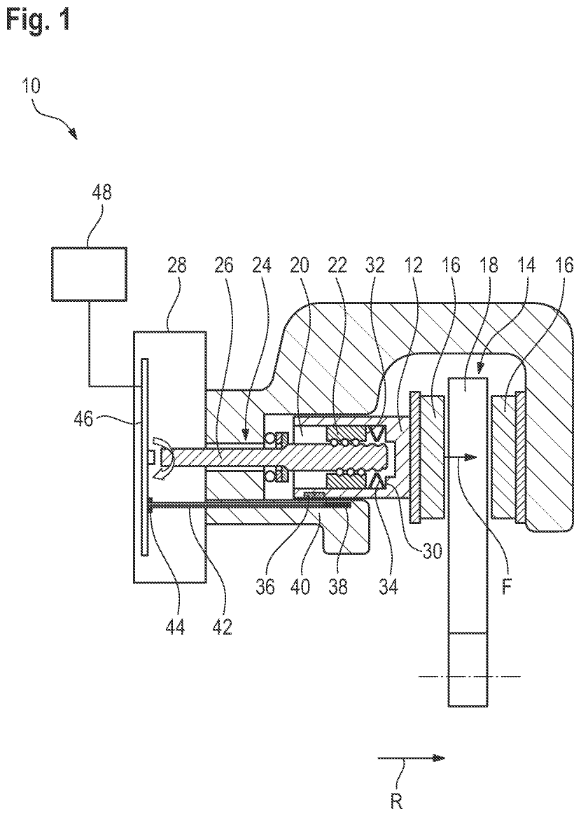

FIG. 1 shows an electromechanical vehicle brake 10 which comprises an actuation piston 12 which acts on a braking assembly 14 and transfers thereto a braking force F.

The braking assembly 14 here is a known floating brake calliper with two brake pads 16 and a brake disc 18 arranged between them.

A ball screw nut 22 of a ball screw drive 24 is received in an inner cavity 20 of the actuation piston 12. A spindle 26 of the ball screw drive 24 is coupled to an electric motor 28, which can set the spindle 26 in rotation, which moves the ball screw nut 22 linearly along the spindle 26.

If the ball screw nut 22 acts on a stop 30 inside the actuation piston 12, which is arranged at longitudinal end of the actuation piston 12 directed toward the braking assembly 14, the ball screw nut moves the actuation piston 12 in the direction of the braking assembly 14, here in the direction of one of the brake pads 16. For this purpose, the actuation piston 12 is freely displaceable opposite the ball screw nut 22 in an actuation direction R, which runs parallel to the longitudinal extent of the spindle 26.

In the cavity 20, a spring element 34 compressible in the actuation direction R is received between an axial end face 32 of the ball screw nut 22 and the stop 30 and has a known force-travel characteristic curve.

On an outer side of the actuation piston 12 there is arranged a signal transmitter 36, which cooperates with a travel sensor 38, which is arranged adjacently to the signal transmitter 36, separated by a narrow air gap. In this example, the travel sensor 38 is received in a recess in a housing 40 of the vehicle brake 10, in which the actuation piston 12 is also guided linearly.

The signal of the travel sensor 38 is a direct measure for the displacement of the actuation piston 12 in the actuation direction R.

The travel sensor 38 is connected via a plug and/or line connection 42, 44 to a printed circuit board 46, which also controls the electric motor 28. The printed circuit board 46 is electronically connected to a control unit 48 or part of the control unit 48, which receives the signals of the travel sensor 38 and can control the electric motor 28.

In one exemplary arrangement, the plug and/or line connection 42, 44 is guided through a bore in the housing 40.

The travel sensor 38 is a Hall sensor, for example. In this case, the signal transmitter 36 is a magnet.

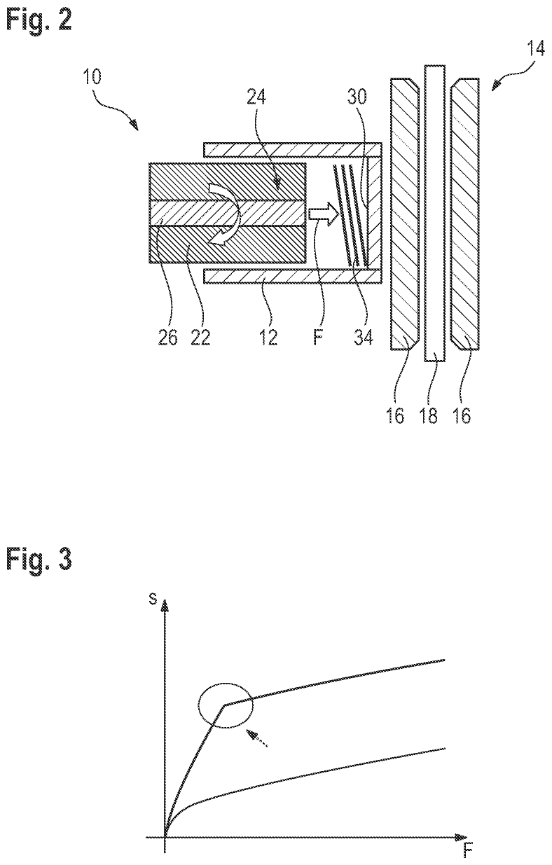

FIG. 2 shows once more in a heavily schematized manner the braking assembly 14, the actuation piston 12 and the ball screw drive 24.

The spring element 34 can be formed in any suitable way, for example as a Belleville washer or Belleville washer set (see FIG. 1) or as a coil spring (see FIG. 2).

FIG. 3 shows, in the upper curve, a force-travel characteristic curve of the vehicle brake 10. A force-travel characteristic curve without the spring element 34 is shown in the lower curve.

If the vehicle brake 10 is to be closed, that is to say the brake pads 16 come to rest against the brake disc 18, in order to exert a braking force F on the braking assembly 14, the spindle 26 is thus set in rotation by the electric motor 28, so that the ball screw nut 22 is displaced in the direction of the braking assembly 14.

The rigidity of the spring element 34 is selected here so that the force is firstly transferred via the spring element 34 to the stop 30 and the actuation piston 12 is displaced in the actuation direction R until the counter force created by the closing of the vehicle brake 10 exceeds a spring force of the spring element 34. After this displacement travel, the actuation piston 12 for example is in abutment against its associated brake pad 16, and the braking assembly 14 is closed to such an extent that there is no longer any play between the brake pads 16 and the brake disc 18. In this position a considerable braking force F must not yet be present at the braking assembly 14.

Since the end face 32 of the ball screw nut 22 is in contact with the spring element 34, the spring element 34 is now compressed during the displacement of the ball screw nut 22, without the braking force applied at the braking assembly 14 increasing significantly. For this purpose, an increasing force is necessary, which is predefined by the force-travel characteristic curve of the spring element 34. Accordingly, the torque of the spindle 26 must be increased, for which purpose the power or the current flow through the electric motor 28 increases. If the compression travel of the spring element 34 is exhausted, the motion energy of the ball screw nut 22 is no longer converted into the compression of the spring element 34, but into a further movement of the actuation piston 12 in the actuation direction R.

This transition establishes itself as a clear bend in the force-travel characteristic curve of the vehicle brake 10 and is shown in FIG. 3. As can also be seen from FIG. 3, the braking force F in the further course is approximately linear to the displacement travel s of the actuation piston 12. If this bend is reached, the necessary torque of the spindle 26 and the power requirement of the electric motor 28 also change accordingly.

The travel sensor 38 detects the current position of the actuation piston 12 via the signal of the signal transmitter 36. For the following application of the actual braking force F, the signal of the travel sensor 38 can now be used to determine the magnitude of the currently applied braking force F and thus to control the closing of the vehicle brake 10.

1. An electromechanical vehicle brake comprising an electric motor and an actuation piston, which acts on a braking assembly, and comprising a ball screw drive which has a spindle rotatable by the electric motor, a ball screw nut displaceable on the spindle, wherein the ball screw nut is received in the actuation piston and cooperates with a stop on an inner axial end of the actuation piston in order to displace the actuation piston in an actuation direction, comprising a spring element, which is arranged in the actuation piston between the stop and the ball screw nut, comprising a travel sensor, which measures a linear displacement of the actuation piston, and comprising a control unit, which is designed to use a signal of the travel sensor under consideration of a characteristic curve of the spring element in order to determine a braking force applied to the braking assembly.

2. The electromechanical vehicle brake according to claim 1, wherein a signal transmitter is arranged on the actuation piston and movement of the actuation piston is detected by the travel sensor.

3. The electromechanical vehicle brake according to claim 1, wherein the travel sensor is a Hall sensor or a capacitive sensor.

4. The electromechanical vehicle brake according to claim 1, wherein the travel sensor is received in a portion of a housing of the vehicle brake adjacent to the actuation piston.

5. The electromechanical vehicle brake according to claim 1, wherein the travel sensor is electrically contacted via a printed circuit board.

6. The electromechanical vehicle brake according to claim 5, wherein the printed circuit board controls the electric motor.

7. The electromechanical vehicle brake according to claim 1, wherein the braking assembly is a floating calliper brake.

8. A method for determining a position of an electromechanical vehicle brake according to claim 1, in which, with the aid of the signal of the travel sensor, which indicates a displacement position of the actuation piston, a braking force currently applied by the actuation piston to the braking assembly is determined under consideration of the characteristic curve of the spring element.

9. The method according to claim 8, wherein a current actuation current of the electric motor is additionally considered.

10. The electromechanical vehicle brake according to claim 2, wherein the travel sensor is a Hall sensor or a capacitive sensor.

11. The electromechanical vehicle brake according to claim 10, wherein the travel sensor is received in a portion of a housing of the vehicle brake adjacent to the actuation piston.

12. The electromechanical vehicle brake according to claim 11, wherein the travel sensor is electrically contacted via a printed circuit board.

13. The electromechanical vehicle brake according to claim 12, wherein the printed circuit board controls the electric motor.

14. The electromechanical vehicle brake according to claim 13, wherein the braking assembly is a floating calliper brake.

15. The electromechanical vehicle brake according to claim 5, wherein the printed circuit board is part of the control unit.

16. The method according to claim 9, wherein a current torque of the spindle is additionally considered.

17. The method according to claim 8, wherein a current actuation current of the electric motor and a current torque of the spindle is additionally considered.
